(19) United States
(12) Patent Application Publication
(10) Pub. No.: US 2010/0006598 A1
(43) Pub. Date: Jan. 14, 2010

(54) Device for a multidrink system

(76) Inventor: Rudiger Cruysberghs, Brussels (BE)

Correspondence Address: STABILPRESS INTERNATIONAL NV, HAACHTSESTEEN WEG 1369, BRUSSELS, 1130, BE

(21) Appl. No.: 12/385,741

(22) Filed: Apr. 17, 2009

Related U.S. Application Data
(60) Provisional application No. 61/124,931, filed on Apr. 21, 2008.

(30) Foreign Application Priority Data
Oct. 25, 2005 (BE) BE2005/0523

(51) Int. Cl. B67D 5/08; B65D 83/14

(52) U.S. Cl. 222/52; 222/635

(57) ABSTRACT

Device for a Multidrink System that is equipped with at least one pressurised container equipped with syrup, concentrate or compound (both fluid and a viscous product) for the production of cold and hot drinks by using at least one control which activates at least one valve of at least one container and thus injects the stated syrups, concentrates or compounds through at least one outflow mouth into hot or cold liquid (namely water) in a recipient, beaker, cup or can.

The invention covers a device (1) to create fluids such as drinks (hot as well as cold or both) by using syrups, concentrates or compounds in fluid to viscous form, which are packed in pressurised containers (2) such as spray cans and where, as a result of a manipulation, the products (i.e. the syrups, concentrates or compounds (6)) are removed from the packaging and placed in a fluid such as water or milk in a recipient (13). According to the invention, the device is extremely suited for producing hot drinks such as (on a non-limiting basis) coffee, chocolate, tea, soups, consommé, mousses and for the creation of cold drinks such as (on a non-limiting basis) fruit juices, cola, lemonades, cold chocolate, iced tea, iced coffee, vegetable juices, cold soups, soft drinks with or without CO2, mousses, cappuccino mousses, flavoured dairy drinks, liqueurs, wines, liqueurs, wines, alcoholic drinks, milkshakes, etc. It is known that these products are packed in powder or fluid form and are mixed in water or milk via a pump or a different mechanism. Another form of packaging is a ready-to-use product in bottles or cans.

A disadvantage of these in the case of ready-to-use products is that these recipients have to be used after opening and that the volume is limited to the volume of the packaging, and that in the case of powder or liquid form these products have to be manipulated by tools such as a pump or screw systems. To cope with these disadvantages, according to the main characteristic of the invention, a device (1) is implemented with one or more pressurised containers (2) which sends one or more products from the containers into the liquid by manipulating the valve on the container. As an advantage and without any limiting character an extensive description is given below of some possible forms of executing the device. This description refers to the enclosed diagram in which:

FIG. 1 shows a device with a container (2)

FIG. 2 shows a device with a container equipped with container cooling (7) and electrical actuation (14) (15)

FIG. 3 shows a device with several containers and a heated liquid stock chamber (8) and a water supply (16) plus a water control valve system (17)

FIG. 4 shows a device with a cooled liquid stock chamber (10) and a water supply (16) and a water control valve system (17)

FIG. 5 shows a device with a heated (8) and cooled stock chamber (10) and a water supply (16) and a water control valve system (17)

FIG. 6 shows a device with a heating element (11) and a cooling element (12) and a water supply (16) and a water control valve system (17)

FIG. 7 shows an electronic operating panel (14) (15) for the applicable device.

In FIG. 1 it can be seen that the device is equipped with one container under pressure and a manual control (5).

In FIG. 2 it can be seen that the device is equipped with one pressurised container that is cooled (7) and equipped with an electrical control (5) based on a magnet or a servo motor that can be equipped with a control such as a PLC or a time setting.

In FIG. 3 it can be seen that the device (1) is equipped with several containers (2) which are equipped or otherwise with cooling (7) of the container (2) and a heated liquid stock chamber (8).

In FIG. 4 it can be seen that the device is equipped with several containers which are equipped or otherwise with cooling (7) of the container (2) and a cooled liquid stock chamber (10).

FIG. 5 shows a device with a heated (8) and a cooled stock chamber (10) and cooling (7) for the container (2)

In FIG. 6 we notice a device (1) with a throughflow heating element (11) and a throughflow cooling element (12) to heat the liquid on the one hand and to cool it on the other. The situation is that if the liquid is heated by a throughflow element the device is more compact and the same applies to the cool throughflow element.

It is also assumed that a device (1) can be connected to an external hot water boiler in order to have a large stock of hot water available externally. It goes without saying that the device as well as the containers can be made from any suitable material and that the dimensions and shape of these can differ depending on the deployment of the containers and possible stock chambers. It is also self-evident that the model and the execution of the holder and cover of the container can be of any suitable type and that the cooling can be of any type. The cooling can be via semi-conductor or gas relief The heat release obtained on the one hand by the semi-conductor and/or via the gas relief may be used as pre-heating for the liquid.

The valve (3) can be operated at both the valve and the container. In the former case we assume that the container is held by a type of holder in the device whereby a magnet or the servo motor (5) activates the valve by pressing on the valve (3) on the one hand or on the other hand by letting the container (2) move. The same can be done manually by using pressure heads (5) or levers. An activation of the valve is obtained by operating the device with the result that products such as syrups, concentrates or compounds in liquid such as water are brought under a certain pressure. This specific pressure ensures that the products will mix with the liquid, so that the drink is obtained. The advantage of injecting under pressure is that the mixing occurs immediately during the injection. Deactivating the valve means that delivery of the products stops. The time of the activation therefore determines the dose of the product being delivered, i.e. syrup, concentrate or compound. Due to the pressure exercised on the product in the container the product is ejected from the container in a specified jet. This jet can be put into the liquid at a specified angle to obtain a specific turbulence to improve the mixing of the product and the liquid. The pressure on the product in the container and the small outflow opening (4) at the valve exit (3) and the outflow mouth (4) means that a controlled flow is created which brusquely terminates on deactivation and which ensures that a minimum of product remains hanging at the outflow mouth. This has the advantage of the fact that the subsequent dripping is kept to a minimum. In most cases there is no subsequent dripping. An additional advantage is that no components of the device (1) are soiled, which means that cleaning is limited to the outflow mouths (4 ) which are attached to the containers (2) and which are also replaced in most cases during the fitting of the containers. Containers (2) may be supplied that are equipped with outflow mouths (4) with hoses that can be attached on a customised basis and in the right direction. Where the case arises there is an assembly advantage relating to the container holders, namely these could be placed in line next to each other.

1. Device for a Multidrink System that is equipped with at least one pressurised container equipped with syrup, concentrate or compound (both fluid and a viscous product) for the production of cold and hot drinks by using at least one control which activates at least one valve of at least one container and thus injects the stated syrups, concentrates or compounds through at least one outflow mouth into hot or cold liquid (namely water) in a recipient, beaker, cup or can.

2. Device for a Multidrink System according to conclusion 1 with the characteristic that the liquid in which the syrups, concentrates or compounds are injected into is hot or cold milk.

3. Device for a Multidrink System according to conclusion 1 and/or 2 with the characteristic that the containers are made out of aluminium.

4. Device for a Multidrink System according to conclusion 1 and/or 2 with the characteristic that the containers are made out of tin.

5. Device for a Multidrink System according to conclusion 1 and/or 2 with the characteristic that the containers are made out of plastic.

6. Device for a Multidrink System according to conclusion 1 and/or 2 with the characteristic that the operation is performed via an electronic control with programmable pressure key functions (14) (15).

7. Device for a Multidrink System according to conclusion 1 and/or 2 with the characteristic that the device (1) is equipped with a water supply (16) and a water control valve system (17)

8. Device for a Multidrink System according to conclusion 1 and/or 2 with the characteristic that the control or more specifically the activation is executed by pneumatic components.

9. Device for a Multidrink System according to conclusion 1 and/or 2 with the characteristic that the operation is manual (5) via manual pressure or transmissions.

10. Device for a Multidrink System according to conclusion 1 and/or 2 with the characteristic that the operation and activation are controlled through a system with payment control such as a coin automaton or credit card reader or other payment systems with internal or external control.

11. Device for a Multidrink System according to conclusion 1 and/or 2 with the characteristic that the holders where the containers are placed are mounted in the device at a specified angle (FIG. 4).

12. Device for a Multidrink System according to conclusion 1 and/or 2 with the characteristic that the pressurised containers are put into the device with an external source of pressure and where applicable the containers are equipped or not equipped with a liner.

13. Device for a Multidrink System according to conclusion 1 and/or 2 with the characteristic that the containers are emptied by quantification based on a pump system and where applicable the containers are equipped or not equipped with a liner

14. Device for a Multidrink System that according to conclusion 1 and/or 2 with the characteristic that several products can be supplied simultaneously.

15. Device for a Multidrink System according to conclusion 1 and/or 2 with the characteristic that products are supplied with a specified controlled quantity, namely a portion with a portion control system.

16. Device for a Multidrink System that according to conclusion 1 and/or 2 with the characteristic that the operation is performed by electromagnets.

17. Device for a Multidrink System according to conclusion 1 and/or 2 with the characteristic that the containers are spray cans like aerosols.

18. Device for a Multidrink System according to conclusion 1 and/or 2 with the characteristic that several products can be supplied from several containers by the control system.

19. Device for a Multidrink System according to conclusion 1 and/or 2 with the characteristic that the one of the drinks can be cappuccino that is made from a combination of several containers.

20. Device for a Multidrink System according to conclusion 1 and/or 2 with the characteristic that the operation is performed pneumatically.

21. Device for a Multidrink System according to conclusion 1 and/or 2 with the characteristic that the device (1) is set up in connections with an external hot water tank with its own heating system.

22. Device for a Multidrink System that according to conclusion 1 and/or 2 with the characteristic that the device (1) is set up in connection with an external cooled water system to supply constantly cooled water.
